(19) United States
(12) Patent Application Publication
(10) Pub. No.: US 2003/0231324 A1
(43) Pub. Date: Dec. 18, 2003

(54) Image processing method and apparatus

(76) Inventor: Makoto Kagaya, Kanagawa (JP)

Correspondence Address: BIRCH STEWART KOLASCH & BIRCH, PO BOX 747, FALLS CHURCH, VA, 22040-0747, US

(21) Appl. No.: 10/378,955

(22) Filed: Mar. 5, 2003

(30) Foreign Application Priority Data
Mar. 5, 2002 (JP) 2002-058164
Mar. 26, 2002 (JP) 2002-085067

(51) Int. Cl. H04N 1/409; G06T 5/00

(52) U.S. Cl. 358/1.9; 358/3.27

(57) ABSTRACT

A kind of an image signal, which has been acquired with a digital camera, and/or image recording conditions associated with the image signal are discriminated. A parameter for sharpness processing, which is to be performed on the image signal, is adjusted in accordance with the kind of the image signal and/or the image recording conditions associated with the image signal, which have thus been discriminated. The sharpness processing is performed on the image signal by use of the thus adjusted parameter for the sharpness processing. The discrimination of the kind of the image signal and/or the image recording conditions associated with the image signal is performed by making an analysis of subsidiary information of the image signal and/or an analysis of the image signal.

### BACKGROUND OF THE INVENTION

1. Field of the Invention

This invention relates to an image processing method and apparatus, wherein sharpness processing is performed on an image signal having been acquired with a digital still camera. This invention also relates to an image processing method and apparatus, wherein graininess transform processing is performed on an image signal representing a photographic image. This invention further relates to a computer program for causing a computer to execute the image processing method, and a computer readable recording medium, on which the computer program has been recorded.

2. Description of the Related Art

Recently, digital still cameras (hereinbelow referred to as the digital cameras) have become popular rapidly. With the digital cameras, in lieu of an image of light information being formed on silver salt film, an image of light information is formed on a digital device (such as a CCD image sensor or a photomultiplier). Also, the image of light information is capable of being stored as a digital signal on a recording medium. Further, the digital signal representing the image is capable of being directly utilized in a computer. Therefore, the digital cameras are convenient for applications, in which digital signals representing images are to be subjected to image processing, or are to be stored.

The image signals, which have been acquired from image recording operations performed with the digital cameras, are capable of being utilized for reproducing visible images by use of image reproducing apparatuses, such as printers or monitors. In cases where the images, which are represented by the image signals having been acquired with the digital cameras, are to be printed with the printers, or are to be displayed on the monitors, it is desired that the images having image quality as good as the image quality of photographs printed from negative film are capable of being obtained. Therefore, it is necessary for various kinds of image processing to be performed on the image signals.

As one of various kinds of image processing, sharpness processing has heretofore been performed. The sharpness processing exerts influences upon image structure characteristics (such as graininess and sharpness) of the reproduced images and plays important roles in enhancement of the image quality of the reproduced images. Therefore, various techniques for the sharpness processing have heretofore been proposed.

The sharpness processing includes, for example, sharpness enhancement processing for acting upon predetermined frequency components, which are contained in an image signal, in order to suppress blur of a contour of the image, and graininess suppression processing for suppressing graininess (noise). As one of the techniques for the sharpness processing, an unsharp masking (USM) sharpness processing technique has heretofore been proposed. With the USM sharpness processing technique, the frequency components contained in an image signal are separated into high frequency components and low frequency components, and sharpness processing, which depends upon contrast, is performed on the high frequency components. Also, a processed image signal is composed from the components, which have thus been obtained from the sharpness processing, and the low frequency components. Ordinarily, with the sharpness enhancement processing, the sharpness of the image is capable of being enhanced, but the problems occur in that the graininess of the image is also enhanced, and a rough feeling remains in the image. Also, ordinarily, with the graininess suppression processing, the graininess of the image is capable of being suppressed, such that the rough feeling of the image is reduced, but the problems occur in that the sharpness of the image becomes low. Therefore, by the utilization of the characteristics such that grainy components have low contrast, and such that image edge components have high contrast, the sharpness processing with the USM sharpness processing technique is designed so as to control the graininess and the sharpness as independent processes by use of different degrees of enhancement (different sharpness gains) for the high frequency components with respect to a region of high contrast and a region of low contrast. The degree of enhancement (the sharpness gain) acts as a parameter for the sharpness processing.

A hyper sharpness processing technique has been proposed in, for example, U.S. Pat. No. 5,739,922. With the proposed hyper sharpness processing technique, image signal components of an image signal are separated into low frequency components, middle frequency components, and high frequency components. The high frequency components are processed by use of a high frequency sharpness gain, and the middle frequency components are processed by use of a middle frequency sharpness gain. Also, a processed image signal is composed from the components, which have been obtained from the processing of the high frequency components, the components, which have been obtained from the processing of the middle frequency components, and the low frequency components.

By way of example, when the USM sharpness processing technique and the hyper sharpness processing technique described above are compared with each other, the USM sharpness processing technique has the advantages in that a processing speed is high, but has the drawbacks in that the effects of the graininess suppression are smaller than the effects of the graininess suppression obtained with the hyper sharpness processing technique. Also, hyper sharpness processing technique has the advantages in that good effects of the graininess suppression are capable of being obtained, but has the drawbacks in that a long time is required for performing the operation processing, and therefore the processing speed is comparatively low.

As described above, different techniques for the sharpness processing have different characteristics, specific advantages, and specific drawbacks.

The image processing performed in conventional image processing apparatuses (or conventional image reproducing apparatuses having image processing functions) is ordinarily set such that the sharpness processing is performed with only one sharpness processing technique. In such cases, as the parameter for the sharpness processing, a value having been set uniquely or a value having been determined by the user is employed.

Also, recently, besides the digital image signals (hereinbelow referred to simply as the image signals) having been acquired from the image recording operations performed with the digital cameras, image signals having been obtained with various kinds of sources, such as the image signals having been acquired by scanning negative film with scanners, are fed into the image reproducing apparatuses, such as printers and monitors. In cases where the thus acquired image signals are fed into the image reproducing apparatuses described above, and visible images are reproduced from the image signals, such that the visible images having good image quality may be obtained, it is necessary for various kinds of image processing to be performed on the image signals.

Image structure transform processing, which is performed as one kind of the image processing, has influences upon the image structure characteristics (such as the graininess and the sharpness) of the reproduced images and plays important roles in enhancement of the image quality of the reproduced images.

However, in cases where the sharpness processing is performed on the image signals having been acquired with the digital cameras, the effects of the sharpness processing, which are required to obtain appropriate image structure characteristics, vary for image signals representing different photographing scenes. For example, as for the image signals representing portrait scenes, the sharpness processing should preferably be performed, such that the degree of graininess suppression is higher than the degree of graininess suppression for other kinds of image signals, such as the image signals representing landscapes, and such that the degree of sharpness enhancement is lower than the degree of sharpness enhancement for other kinds of image signals, such as the image signals representing landscapes. Also, as for the image signals representing long time exposure photographing scenes, the sharpness processing should preferably be performed, such that the degree of graininess suppression is higher than the degree of graininess suppression for other kinds of image signals. Further, as for the under-exposure image signals having been acquired with under-exposure and the image signals having been acquired from the image recording operations using a flashlight, the degrees of the sharpness processing necessary for appropriate images to be obtained vary from the degrees of the sharpness processing for other kinds of image signals. Therefore, the conventional image processing apparatuses, wherein the sharpness processing is performed on the image signals, which have been acquired from the image recording operations performed with the digital cameras, by use of the uniquely set parameter for the sharpness processing, have the problems in that reproduced images having desirable image structure characteristics cannot be obtained from certain kinds of image signals.

Also, special knowledge is required to perform manual adjustments of the parameter for the sharpness processing, and it is not always possible for the user to adjust the parameter at an appropriate value.

Further, as described above, different techniques for the sharpness processing have different characteristics, specific advantages, and specific drawbacks. Therefore, there is a strong demand for a technique, wherein the characteristics of different techniques for the sharpness processing are utilized, and efficient sharpness processing is capable of being performed on the image signals having been acquired with the digital cameras.

Furthermore, the graininess characteristics of the image signals vary for different kinds of sources of the image signals (such as negative film, digital cameras, and scanners used for acquiring the image signals from negative film). The conventional image processing apparatuses (or conventional image reproducing apparatuses having the image processing functions) described above are ordinarily designed such that, in cases where the image structure transform processing is performed with respect to the image signals having been obtained from different kinds of sources, the image structure transform processing is performed by use of the parameter for the image structure transform having been set uniquely. Therefore, the conventional image processing apparatuses (or conventional image reproducing apparatuses having the image processing functions) described above have the problems in that the reproduced images having appropriate graininess characteristics cannot be obtained, and in that the effects of the image structure transform processing cannot be obtained reliably.

Also, in the cases of photographic images, there are strict requirements for the image structure characteristics of face image regions in images of persons for reasons of the human's visual characteristics, and there is a strong demand for a technique, with which an appropriate level of graininess is capable of being obtained.

### SUMMARY OF THE INVENTION

The primary object of the present invention is to provide an image processing method, wherein sharpness processing is performed on each of image signals, which have been acquired from image recording operations performed with digital cameras, such that images having good image quality are capable of being obtained in a simple manner from different kinds of image signals.

Another object of the present invention is to provide an image processing method, wherein image structure transform processing is performed on each of image signals having been acquired from different kinds of sources, particularly image signals representing photographic images, besides image signals having been acquired with digital cameras, such that effects of image structure transform are capable of being obtained reliably with respect to the image signals having been acquired from different kinds of sources, and such that images appropriate for human's visual characteristics are capable of being obtained from the image signals having been acquired from different kinds of sources.

A further object of the present invention is to provide an apparatus for carrying out the image processing method.

A still further object of the present invention is to provide a computer program for causing a computer to execute the image processing method.

The specific object of the present invention is to provide a computer readable recording medium, on which the computer program has been recorded.

Each of a first image processing method, a first image processing apparatus, a first computer program, a second image processing method, a second image processing apparatus, and a second computer program in accordance with the present invention performs processing on an image signal having been acquired with a digital camera and achieves the first mentioned object of the present invention. Each of a third image processing method, a third image processing apparatus, and a third computer program in accordance with the present invention performs processing on a photographic image signal and achieves the second mentioned object of the present invention. The photographic image signal, which is processed by each of the third image processing method, the third image processing apparatus, and the third computer program in accordance with the present invention is not limited to the photographic image signal, which has been acquired with the digital camera, and includes one of photographic image signals, which have been acquired from a wide variety of kinds of sources, such as photographic image signals having been acquired by scanning photographic film or prints with scanners, and the like.

The present invention provides a first image processing method, in which sharpness processing is performed on an image signal having been acquired with a digital camera, the method comprising the steps of:

i) discriminating a kind of the image signal and/or image recording conditions associated with the image signal,

ii) adjusting a parameter for the sharpness processing, which is to be performed on the image signal, in accordance with the kind of the image signal and/or the image recording conditions associated with the image signal, which have thus been discriminated, and

iii) performing the sharpness processing on the image signal by use of the thus adjusted parameter for the sharpness processing.

The first image processing method in accordance with the present invention should preferably be modified such that the discrimination of the kind of the image signal and/or the image recording conditions associated with the image signal is performed by making an analysis of subsidiary information of the image signal and/or an analysis of the image signal.

The present invention also provides a second image processing method, in which sharpness processing is performed on an image signal having been acquired with a digital camera, the method comprising the steps of:

i) discriminating a kind of the image signal and/or image recording conditions associated with the image signal,

ii) selecting a technique for the sharpness processing, which is to be performed on the image signal, in accordance with the kind of the image signal and/or the image recording conditions associated with the image signal, which have thus been discriminated, and

iii) performing the sharpness processing on the image signal by use of the thus selected technique for the sharpness processing.

The second image processing method in accordance with the present invention should preferably be modified such that the discrimination of the kind of the image signal and/or the image recording conditions associated with the image signal is performed by making an analysis of subsidiary information of the image signal and/or an analysis of the image signal.

By way of example, in cases where the image signal is the one conforming to an Exif format, the subsidiary information of the image signal corresponds to tag information. The tag information specifies pieces of information, such as an object distance, an exposure time, an exposure program, and electronic flash equipment information, depending upon the type of the digital camera. In cases where the subsidiary information of the image signal is analyzed, it is possible to discriminate the kind of the image signal, for example, as to whether the image signal is or is not a portrait image signal, whether the image signal is or is not the one having been acquired from a long time exposure image recording operation, whether the image signal is an under-exposure image signal, and whether the image signal is or is not the one having been obtained from an image recording operation using a flashlight.

Also, besides the analysis of the subsidiary information of the image signal, the kind of the image signal is capable of being discriminated by making an analysis of the image signal. For example, a mean value of luminance values of the entire area of the image, which is represented by the image signal, maybe calculated and taken as a lightness of the image. Also, in cases where the lightness is smaller than a predetermined threshold value, it may be judged that the image signal is the one having been acquired from an under-exposure image recording operation.

The present invention further provides a first image processing apparatus for carrying out the first image processing method in accordance with the present invention. Specifically, the present invention further provides a first image processing apparatus, in which sharpness processing is performed on an image signal having been acquired with a digital camera, the apparatus comprising:

i) discrimination means for discriminating a kind of the image signal and/or image recording conditions associated with the image signal, and

ii) processing means for adjusting a parameter for the sharpness processing, which is to be performed on the image signal, in accordance with the kind of the image signal and/or the image recording conditions associated with the image signal, which have been discriminated by the discrimination means, and performing the sharpness processing on the image signal by use of the thus adjusted parameter for the sharpness processing.

The first image processing apparatus in accordance with the present invention should preferably be modified such that the discrimination means performs the discrimination of the kind of the image signal and/or the image recording conditions associated with the image signal by making an analysis of subsidiary information of the image signal and/or an analysis of the image signal.

The present invention still further provides a second image processing apparatus for carrying out the second image processing method in accordance with the present invention. Specifically, the present invention still further provides a second image processing apparatus, in which sharpness processing is performed on an image signal having been acquired with a digital camera, the apparatus comprising:

i) discrimination means for discriminating a kind of the image signal and/or image recording conditions associated with the image signal, and

ii) processing means for selecting a technique for the sharpness processing, which is to be performed on the image signal, in accordance with the kind of the image signal and/or the image recording conditions associated with the image signal, which have been discriminated by the discrimination means, and performing the sharpness processing on the image signal by use of the thus selected technique for the sharpness processing.

The second image processing apparatus in accordance with the present invention should preferably be modified such that the discrimination means performs the discrimination of the kind of the image signal and/or the image recording conditions associated with the image signal by making an analysis of subsidiary information of the image signal and/or an analysis of the image signal.

The present invention also provides a first computer program for causing a computer to execute processing, in which sharpness processing is performed on an image signal having been acquired with a digital camera, the computer program comprising the procedures for:

i) a discrimination process for discriminating a kind of the image signal and/or image recording conditions associated with the image signal,

ii) a parameter adjusting process for adjusting a parameter for the sharpness processing, which is to be performed on the image signal, in accordance with the kind of the image signal and/or the image recording conditions associated with the image signal, and

iii) an execution process for performing the sharpness processing on the image signal by use of the adjusted parameter for the sharpness processing.

The present invention further provides a second computer program for causing a computer to execute processing, in which sharpness processing is performed on an image signal having been acquired with a digital camera, the computer program comprising the procedures for:

i) a discrimination process for discriminating a kind of the image signal and/or image recording conditions associated with the image signal,

ii) a technique selecting process for selecting a technique for the sharpness processing, which is to be performed on the image signal, in accordance with the kind of the image signal and/or the image recording conditions associated with the image signal, and

iii) an execution process for performing the sharpness processing on the image signal by use of the selected technique for the sharpness processing.

The present invention still further provides a third image processing method, comprising the steps of:

i) storing information, which represents a reference graininess of a face image region embedded in a photographic image,

ii) extracting image signal components, which represent the face image region, from an image signal representing the photographic image,

iii) calculating graininess of the face image region from the thus extracted image signal components, which represent the face image region,

iv) adjusting a parameter for graininess transform processing, which is to be performed on the image signal, such that the graininess of the face image region becomes close to the reference graininess of the face image region, and

v) performing the graininess transform processing by use of the thus adjusted parameter for the graininess transform processing.

The term “photographic image” as used here in means the image, in which an image pattern of a person is embedded.

The term “graininess of an image signal” as used herein means the graininess of the image represented by the image signal. In this specification, the term “graininess of an image signal” has the same meaning as the graininess of the image represented by the image signal.

The term “graininess transform processing” as used herein means the processing for transforming the graininess of the image or the image signal. Specifically, for example, the graininess transform processing may be the processing for acting upon predetermined frequency components contained in the image (or the image signal) in order to suppress or enhance the graininess (noise). Besides the graininess transform processing, the image structure transform processing also includes the sharpness enhancement processing for suppressing blur of the contour of the image, and the like. Ordinarily, with the sharpness enhancement processing, the sharpness of the image is capable of being enhanced, but the problems occur in that the graininess of the image is also enhanced, and a rough feeling remains in the image. Also, ordinarily, with the graininess suppression processing, the graininess of the image is capable of being suppressed, such that the rough feeling of the image is reduced, but the problems occur in that the sharpness of the image becomes low. In the third image processing method in accordance with the present invention, the graininess transform processing should preferably be the graininess transform processing in the image structure transform processing, in which the graininess and the sharpness are capable of being controlled as independent processes. Various techniques for the image structure transform processing, in which the graininess and the sharpness are capable of being controlled as independent processes, have heretofore been proposed. As one of the techniques for the image structure transform processing, a contrast-dependent USM (unsharp masking) technique has heretofore been proposed. With the image structure transform processing in accordance with the contrast-dependent USM technique, the frequency components contained in the image signal are separated into the high frequency components and the low frequency components, and the high frequency components are adjusted in dependence upon the contrast. In this manner, the graininess and the sharpness are controlled as independent processes. Ordinarily, the grainy components have low contrast, and the image edge components have high contrast. Therefore, with the image structure transform processing in accordance with the contrast-dependent USM technique, the graininess and the sharpness are controlled as independent processes by use of different degrees of enhancement (different sharpness gains) for the high frequency components with respect to the region of high contrast and the region of low contrast. In such cases, the enhancement (or suppression) processing with respect to the grainy components, i.e. the sharpness processing with respect to the low contrast components, corresponds to the graininess transform processing employed in the third image processing method in accordance with the present invention. Also, the degree of enhancement with respect to the grainy components, i.e. the sharpness gain with respect to the low contrast components, corresponds to the parameter for the graininess transform processing employed in the third image processing method in accordance with the present invention.

The term “image signal representing a photographic image” as used herein means the digital image signal representing the photographic image. By way of example, the digital image signal may be an image signal, which has been acquired from an image recording operation performed with the digital still camera. Alternatively, the digital image signal may be an image signal, which has been acquired by reading out an image from negative film by use of a read-out apparatus, such as a scanner.

The present invention also provides a third image processing apparatus for carrying out the third image processing method in accordance with the present invention. Specifically, the present invention also provides a third image processing apparatus, comprising:

i) storage means for storing information, which represents a reference graininess of a face image region embedded in a photographic image,

ii) extraction means for extracting image signal components, which represent the face image region, from an image signal representing the photographic image,

iii) graininess calculating means for calculating graininess of the face image region from the extracted image signal components, which represent the face image region,

iv) parameter adjusting means for adjusting a parameter for graininess transform processing, which is to be performed on the image signal, such that the graininess of the face image region becomes close to the reference graininess of the face image region, and

v) transform means for performing the graininess transform processing by use of the parameter for the graininess transform processing, which parameter has been adjusted by the parameter adjusting means.

The present invention further provides a third computer program for causing a computer to execute processing, in which graininess transform processing is performed on an image signal representing a photographic image, the computer program comprising the procedures for:

i) an extraction process for extracting image signal components, which represent a face image region, from the image signal representing the photographic image,

ii) a graininess calculating process for calculating graininess of the face image region from the extracted image signal components, which represent the face image region,

iii) a parameter adjusting process for adjusting a parameter for graininess transform processing, which is to be performed on the image signal, such that the graininess of the face image region becomes close to the reference graininess of the face image region, and

iv) a transform process for performing the graininess transform processing on the image signal by use of the adjusted parameter for the graininess transform processing.

The present invention still further provides a computer readable recording medium, on which each of the first to third computer programs for causing a computer to execute the processing in accordance with the present invention has been recorded.

A skilled artisan would know that the computer readable recording medium is not limited to any specific type of storage devices and includes any kind of device, including but not limited to CDs, floppy disks, RAMs, ROMs, hard disks, magnetic tapes and internet downloads, in which computer instructions can be stored and/or transmitted. Transmission of the computer code through a network or through wireless transmission means is also within the scope of the present invention. Additionally, computer code/instructions include, but are not limited to, source, object, and executable code and can be in any language including higher level languages, assembly language, and machine language.

With the first image processing method and apparatus in accordance with the present invention, in which the sharpness processing is performed on the image signal having been acquired with the digital camera, the kind of the image signal and/or the image recording conditions associated with the image signal are discriminated, and the parameter for the sharpness processing, which is to be performed on the image signal, is adjusted in accordance with the kind of the image signal and/or the image recording conditions associated with the image signal, which have thus been discriminated. Also, the sharpness processing is performed on the image signal by use of the thus adjusted parameter for the sharpness processing. Therefore, the sharpness processing appropriate for the kind of the image signal and/or the image recording conditions associated with the image signal is capable of being performed, and the image quality of the image obtained from the processing is capable of being enhanced.

With the second image processing method and apparatus in accordance with the present invention, in which the sharpness processing is performed on the image signal having been acquired with the digital camera, the kind of the image signal and/or the image recording conditions associated with the image signal are discriminated, and the technique for the sharpness processing, which is to be performed on the image signal, is selected in accordance with the kind of the image signal and/or the image recording conditions associated with the image signal, which have thus been discriminated. Also, the sharpness processing is performed on the image signal by use of the thus selected technique for the sharpness processing. Therefore, efficient sharpness processing is capable of being performed by the utilization of the characteristics of each of various techniques for the sharpness processing. For example, in the cases of an image signal (e.g., a portrait image signal), for which it is necessary to suppress the graininess strongly, a sharpness processing technique having the characteristics, such that the processing speed is comparatively low, but the effects of graininess suppression are large, may be employed. Also, in the cases of an image signal, for which it is not necessary to perform strong graininess suppression, a sharpness processing technique having the characteristics, such that the effects of graininess suppression are comparatively small, but the processing speed is high, may be employed. In this manner, the effects of the sharpness processing appropriate for the kind of the image signal and/or the image recording conditions associated with the image signal are capable of being obtained, and the effects of the sharpness processing are capable of being enhanced.

The third image processing method and apparatus in accordance with the present invention are based upon the findings in that, as for reproduced photographic images, and the like, there are strict requirements for the graininess characteristics of face image regions in images of persons. Specifically, with the third image processing method and apparatus in accordance with the present invention, the information, which represents the reference graininess of the face image region embedded in the photographic image, is stored, and the image signal components, which represent the face image region, are extracted from the image signal representing the photographic image. Also, the graininess of the face image region is calculated from the thus extracted image signal components, which represent the face image region, and the parameter for the graininess transform processing, which is to be performed on the image signal, is adjusted such that the graininess of the face image region becomes close to the reference graininess of the face image region. The graininess transform processing is then performed by use of the thus adjusted parameter for the graininess transform processing. Therefore, images having a desirable grainy feeling are capable of being obtained from the image signals, which have been acquired from different kinds of sources, and the effects of image structure transform are capable of being obtained reliably with respect to the image signals, which have been acquired from different kinds of sources.

### BRIEF DESCRIPTION OF THE DRAWINGS

FIG. 1 is a block diagram showing a first embodiment of the image processing apparatus in accordance with the present invention,

FIG. 2 is a flow chart showing how the image processing apparatus of FIG. 1 operates,

FIG. 3 is a flow chart showing how a scene judging means of the image processing apparatus of FIG. 1 operates,

FIG. 4 is a block diagram showing a second embodiment of the image processing apparatus in accordance with the present invention, which is constituted as a printing system,

FIG. 5A is a graph showing frequency characteristics of a face image region embedded in a photographic image,

FIG. 5B is a graph showing frequency response characteristics of a human's visual system,

FIG. 5C is a graph showing frequency characteristics of the face image region embedded in the photographic image, which frequency characteristics have been corrected by use of the frequency response characteristics of the human's visual system, and

FIG. 6 is a graph showing a relationship between a sharpness gain and contrast.

### DESCRIPTION OF THE PREFERRED EMBODIMENTS

The present invention will hereinbelow be described in further detail with reference to the accompanying drawings.

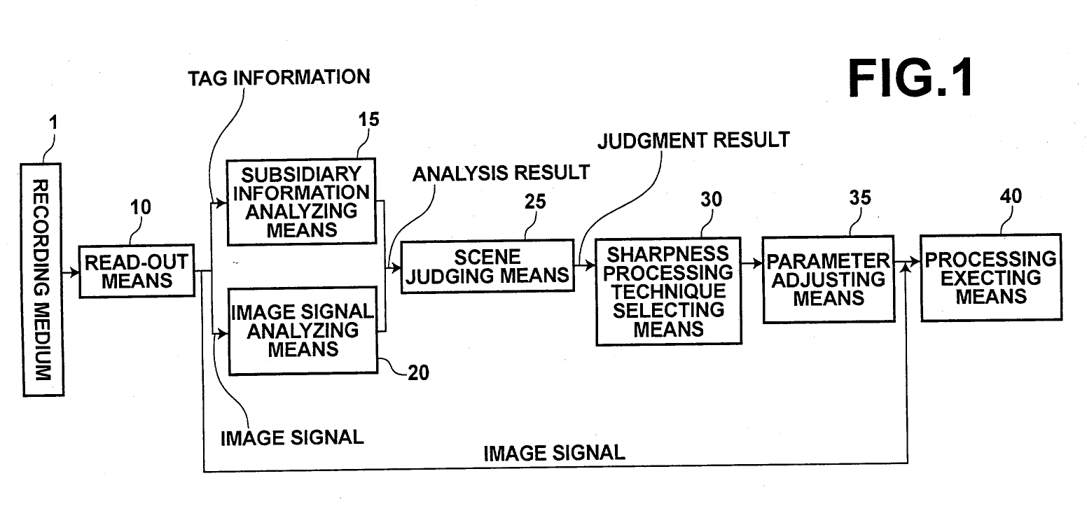

FIG. 1 is a block diagram showing a first embodiment of the image processing apparatus in accordance with the present invention.

As illustrated in FIG. 1, the first embodiment of the image processing apparatus in accordance with the present invention comprises read-out means 10 for reading out an image signal conforming to the Exif format, which image signal has been obtained from an image recording operation performed with a digital camera, from a recording medium 1 of the digital camera. The image processing apparatus also comprises subsidiary information analyzing means 15 for making an analysis of tag information of the image signal. The image processing apparatus further comprises image signal analyzing means 20 for making an analysis of the image signal. The image processing apparatus still further comprises scene judging means 25 for making a judgment as to the kind of an image recording scene of the image signal (the kind of the image signal) in accordance with the results of analyses, which have been made by the subsidiary information analyzing means 15 and the image signal analyzing means 20. The image processing apparatus also comprises sharpness processing technique selecting means 30 for selecting a technique for sharpness processing, which is to be performed on the image signal, in accordance with the kind of the image recording scene, which has been judged by the scene judging means 25. The image processing apparatus further comprises parameter adjusting means 35 for adjusting a parameter for the sharpness processing, which is to be performed on the image signal by use of the sharpness processing technique having been selected by the sharpness processing technique selecting means 30. The image processing apparatus still further comprises processing executing means 40 for executing the sharpness processing on the image signal by use of the sharpness processing technique, which has been selected by the sharpness processing technique selecting means 30, and the parameter, which has been adjusted by the parameter adjusting means 35. In this embodiment, the sharpness processing technique selecting means 30 selects an appropriate sharpness processing technique from the USM sharpness processing technique and the hyper sharpness processing technique described above.

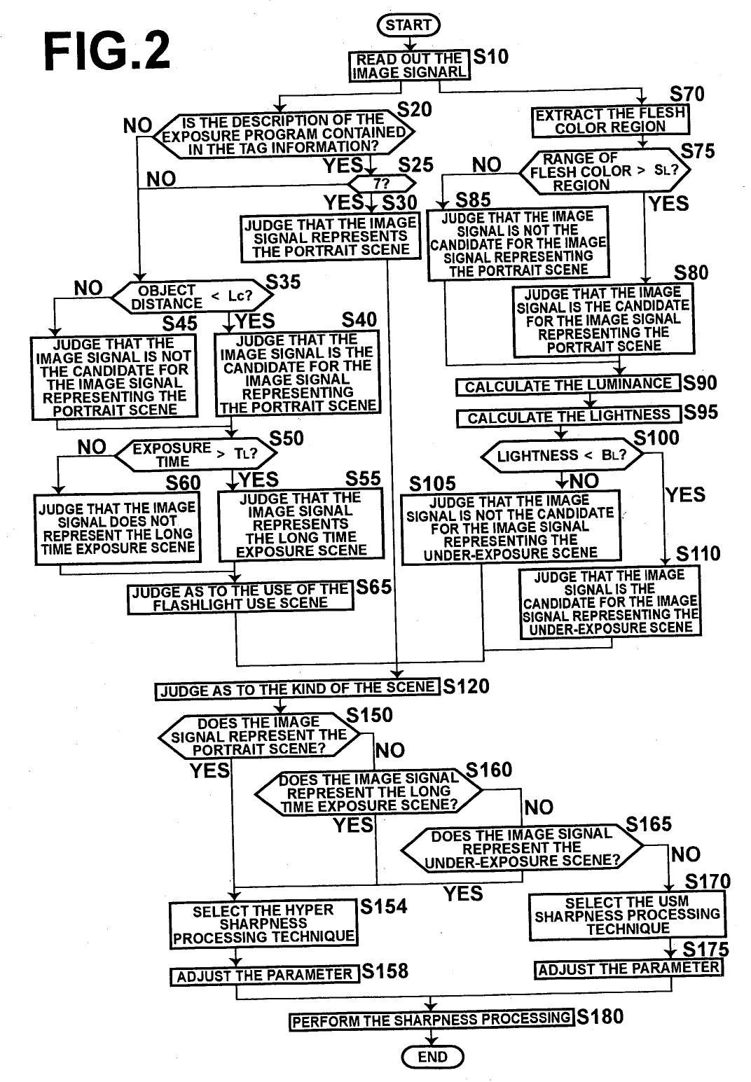

FIG. 2 is a flow chart showing how the image processing apparatus of FIG. 1 operates. Operations of the image processing apparatus shown in FIG. 1 will hereinbelow be described in detail with reference to the flow chart of FIG. 2. As illustrated in FIG. 2, in this embodiment of the image processing apparatus in accordance with the present invention, in a step S10, the image signal, which has been obtained from the image recording operation performed with the digital camera, is read out from the recording medium 1 of the digital camera. Also, in steps S20 to S110, the tag information acting as the subsidiary information of the image signal is analyzed by the subsidiary information analyzing means 15, and the image signal is analyzed by the image signal analyzing means 20. The steps S20 to S65 represent the operations of the subsidiary information analyzing means 15. Steps S70 to S110 represent the operations of the image signal analyzing means 20. Firstly, how the subsidiary information analyzing means 15 operates will be described hereinbelow.

As illustrated in FIG. 2, in the step S20, the subsidiary information analyzing means 15 confirms whether a description of an exposure program is or is not contained in the tag information of the image signal, which has been read out by the read-out means 10. In cases where the description of the exposure program is contained in the tag information of the image signal (S20: Yes), and the value of the description is “7” (S25: Yes), in the step S30, the subsidiary information analyzing means 15 judges that the image signal appended with the subsidiary information is the image signal representing a portrait scene. Also, the subsidiary information analyzing means 15 feeds out information representing the results of the analysis to the scene judging means 25 and finishes the analysis.

In cases where the description of the exposure program is not contained in the tag information of the image signal (S20: No), or in cases where the description of the exposure program is contained in the tag information of the image signal, and the value of the description is not “7” (S25: No), in the step S35, the subsidiary information analyzing means 15 confirms a description of an object distance contained in the tag information. In cases where the value of the object distance is smaller than a predetermined object distance threshold value Lc (S35: Yes), in the step S40, the subsidiary information analyzing means 15 judges that the image signal appended with the subsidiary information is a candidate for the image signal representing the portrait scene. In cases where the value of the object distance is not smaller than the predetermined object distance threshold value Lc (S35: No), in the step S45, the subsidiary information analyzing means 15 judges that the image signal appended with the subsidiary information is not the candidate for the image signal representing the portrait scene. Thereafter, in the step S50, the subsidiary information analyzing means 15 confirms a description of an exposure time contained in the tag information. In cases where the value of the exposure time is larger than a predetermined exposure time threshold value T_{L} (S50: Yes), in the step S55, the subsidiary information analyzing means 15 judges that the image signal appended with the subsidiary information is the image signal representing a long time exposure scene. In cases where the value of the exposure time is not larger than the predetermined exposure time threshold value T_{L} (S50: No), in the step S60, the subsidiary information analyzing means 15 judges that the image signal appended with the subsidiary information is not the image signal representing the long time exposure scene. In the step S65, the subsidiary information analyzing means 15 then confirms flashlight use information contained in the tag information. In cases where the value of the flashlight use information is a value other than “0,” the subsidiary information analyzing means 15 judges that the image signal appended with the subsidiary information is the image signal representing a flashlight use scene. In cases where the value of the flashlight use information is a value of “0,” the subsidiary information analyzing means 15 judges that the image signal appended with the subsidiary information is not the image signal representing the flashlight use scene.

The subsidiary information analyzing means 15 feeds out the information, which represents all of the results of the analysis, to the scene judging means 25. In the scene judging means 25, the information received from the subsidiary information analyzing means 15 is utilized for making a judgment as to the scene.

Also, in the step S70, the image signal analyzing means 20 performs a process for extracting a flesh color region on the image signal, which has been read out by the read-out means 10. In the step S75, the image signal analyzing means 20 makes a judgment as to whether the ratio of the area of the extracted flesh color region to the entire area of the image (i.e., the range of the flesh color region) is or is not larger than a predetermined threshold value S_{L}. In cases where the range of the flesh color region is larger than the predetermined threshold value S_{L} (S75: Yes), in the step S80, the image signal analyzing means 20 judges that the image signal is the candidate for the image signal representing the portrait scene. In cases where the range of the flesh color region is not larger than the predetermined threshold value S_{L} (S75: No), in the step S85, the image signal analyzing means 20 judges that the image signal is not the candidate for the image signal representing the portrait scene. In the step S90, the image signal analyzing means 20 then calculates the luminance of each of pixels in the image represented by the image signal. Further, in the step S95, the image signal analyzing means 20 calculates a mean value of the luminance values of the pixels in the image and takes the calculated mean value as the lightness of the image signal. Thereafter, in the step S100, the image signal analyzing means 20 makes a judgment as to whether the lightness of the image signal is or is not smaller than a predetermined lightness threshold value B_{L}. In cases where the lightness of the image signal is smaller than the predetermined lightness threshold value B_{L} (S100: Yes), in the step S110, the image signal analyzing means 20 judges that the image signal is a candidate for the image signal representing an under-exposure scene. In cases where the lightness of the image signal is not smaller than the predetermined lightness threshold value B_{L} (S100: No), in the step S105, the image signal analyzing means 20 judges that the image signal is not the candidate for the image signal representing the under-exposure scene.

The image signal analyzing means 20 feeds out the information, which represents the results of the analysis, i.e., the information representing whether the image signal is or is not the candidate for the image signal representing the portrait scene, and the information representing whether the image signal is or is not the candidate for the image signal representing the under-exposure scene, to the scene judging means 25. In the scene judging means 25, the information received from the image signal analyzing means 20 is utilized for making a judgment as to the scene.

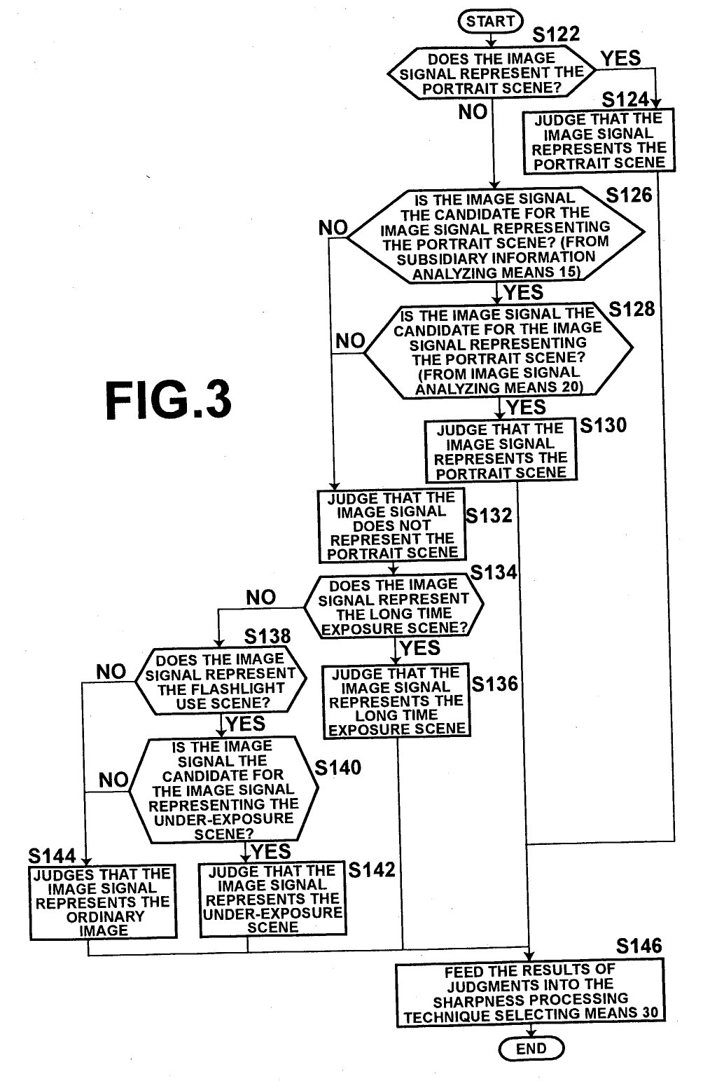

In a step S120, the scene judging means 25 makes a judgment as to the kind of the scene, which is represented by the image signal, in accordance with the results of the analyses having been made by the subsidiary information analyzing means 15 and the image signal analyzing means 20 on the image signal. How the scene judging means 25 makes the judgment as to the kind of the scene, which is represented by the image signal, will hereinbelow be described in detail with reference to FIG. 3. As illustrated in FIG. 3, in a step S122, the scene judging means 25 receives the information, which represents the results of the analyses, from the subsidiary information analyzing means 15 and the image signal analyzing means 20 and makes a judgment as to whether the result of the analysis having been made by the subsidiary information analyzing means 15 indicates or does not indicate that the image signal is the image signal representing the portrait scene. In cases where the result of the analysis having been made by the subsidiary information analyzing means 15 indicates that the image signal is the image signal representing the portrait scene (S122: Yes), in a step S124, the scene judging means 25 judges that the image signal is the image signal representing the portrait scene. Also, in a step S146, the scene judging means 25 feeds out the information, which represents the result of the judgment, to the sharpness processing technique selecting means 30 and finishes the process for judging the scene represented by the image signal.

In cases where, in the step S122, the result of the analysis having been made by the subsidiary information analyzing means 15 does not indicate that the image signal is the image signal representing the portrait scene (S122: No), in a step S126, the scene judging means 25 makes a judgment as to whether the result of the analysis having been made by the subsidiary information analyzing means 15 indicates or does not indicate that the image signal is the candidate for the image signal representing the portrait scene. Also, in a step S128, the scene judging means 25 makes a judgment as to whether the result of the analysis having been made by the image signal analyzing means 20 indicates or does not indicate that the image signal is the candidate for the image signal representing the portrait scene. In cases where both the result of the analysis, which has been made by the subsidiary information analyzing means 15, and the result of the analysis, which has been made by the image signal analyzing means 20, indicate that the image signal is the candidate for the image signal representing the portrait scene (S126: Yes, S128: Yes), in a step S130, the scene judging means 25 judges that the image signal is the image signal representing the portrait scene. Also, in such cases, in the step S146, the scene judging means 25 feeds out the information, which represents the result of the judgment, to the sharpness processing technique selecting means 30 and finishes the process for judging the scene represented by the image signal.

In cases where at least either one of the result of the analysis, which has been made by the subsidiary information analyzing means 15, and the result of the analysis, which has been made by the image signal analyzing means 20, indicates that the image signal is not the candidate for the image signal representing the portrait scene (S126: No; or S126: Yes, S128: No), in a step S132, the scene judging means 25 judges that the image signal is not the image signal representing the portrait scene. Also, in a step S134, the scene judging means 25 confirms the result of the analysis concerning the long time exposure, which result is contained in the result of the analysis having been made by the subsidiary information analyzing means 15. In cases where the result of the analysis concerning the long time exposure indicates that the image signal is the image signal representing the long time exposure scene (S134: Yes), in a step S136, the scene judging means 25 judges that the image signal is the image signal representing the long time exposure scene. Also, in such cases, in the step S146, the scene judging means 25 feeds out the information, which represents the result of the judgment, to the sharpness processing technique selecting means 30 and finishes the process for judging the scene represented by the image signal.

In cases where, in the step S134, the result of the analysis concerning the long time exposure, which analysis has been made by the subsidiary information analyzing means 15, indicates that the image signal is not the image signal representing the long time exposure scene (S134: No), in a step S138, in accordance with the result of the analysis having been made by the subsidiary information analyzing means 15, the scene judging means 25 makes a judgment as to whether the image signal is or is not the image signal representing the flashlight use scene. Also, in a step S140, in accordance with the result of the analysis having been made by the image signal analyzing means 20, the scene judging means 25 makes a judgment as to whether the image signal is or is not the candidate for the image signal representing the under-exposure scene. In a step S142, the scene judging means 25 judges that the image signal, which satisfies the three conditions in that the image signal is not the image signal representing the long time exposure scene, in that the image signal is the image signal representing the flashlight use scene, and in that the image signal is the candidate for the image signal representing the under-exposure scene (S134: No, S138: Yes, S140: Yes), is the image signal representing the under-exposure scene. Further, in such cases, in the step S146, the scene judging means 25 feeds out the information, which represents the result of the judgment, to the sharpness processing technique selecting means 30 and finishes the process for judging the scene represented by the image signal.

In a step S144, the scene judging means 25 judges that an image signal other than the image signal, which has been judged as being the image signal representing the portrait scene, representing the long time exposure scene, and representing the under-exposure scene, is the image signal representing an ordinary image. In the step S146, the result of the judgment, which indicates that the image signal is the image signal representing the ordinary image, is also fed out into the sharpness processing technique selecting means 30.

In the step S120 described above, the scene judging means 25 operates in the manner described above. Reverting to the flow chart of FIG. 2, the operation of the sharpness processing technique selecting means 30 for selecting a technique for the sharpness processing, which is to be performed on the image signal, in accordance with the results of the judgments obtained from the step S120, and the operations which follow will be described hereinbelow.

In a step S150, the sharpness processing technique selecting means 30 receives the information, which represents the results of the judgments having been made on the image signal, from the scene judging means 25 and makes a judgment as to whether the image signal is or is not the image signal representing the portrait scene. In cases where the results of the judgments indicate that the image signal is the image signal representing the portrait scene (S150: Yes), in a step S154, the sharpness processing technique selecting means 30 selects the hyper sharpness processing technique as the technique for the sharpness processing, which is to be performed on the image signal. Also, in a step S158, the parameter for the sharpness processing, which is to be performed on the image signal with the hyper sharpness processing technique, is adjusted by the parameter adjusting means 35.

In the same manner, as for the image signal representing the long time exposure scene (S150: No, S160: Yes) and the image signal representing the under-exposure scene (S150: No, S160: No, S165: Yes), in the step S154, the sharpness processing technique selecting means 30 selects the hyper sharpness processing technique as the technique for the sharpness processing, which is to be performed on the image signal. Also, in such cases, in the step S158, the parameter for the sharpness processing, which is to be performed on the image signal with the hyper sharpness processing technique, is adjusted by the parameter adjusting means 35.

In cases where the sharpness processing is performed on the image signal representing the portrait scene, the sharpness processing should preferably be conducted such that the effects of the graininess suppression are larger than the effects of the graininess suppression on the ordinary image, and such that the effects of the sharpness enhancement are smaller than the effects of the sharpness enhancement on the ordinary image. Therefore, as for the image signal representing the portrait scene, the parameter adjusting means 35 adjusts the parameter for the graininess suppression at a value larger than value of the parameter for the graininess suppression performed on the ordinary image and adjusts the parameter for the sharpness enhancement at a value smaller than the value of the parameter for the sharpness enhancement performed on the ordinary image.

As for the image signal representing the long time exposure scene and the image signal representing the under-exposure scene, the parameter adjusting means 35 adjusts the parameter for the graininess suppression at a value larger than value of the parameter for the graininess suppression performed on the ordinary image and adjusts the parameter for the sharpness enhancement at a value identical with the value of the parameter for the sharpness enhancement performed on the ordinary image.

With respect to the image signal representing the ordinary image (S150: No, S160: No, S165: No), in a step S170, the sharpness processing technique selecting means 30 selects the USM sharpness processing technique, which has the characteristics such that the effects the graininess suppression are not very large as in the hyper sharpness processing technique, but the processing speed is high. Also, in a step S175, the parameter adjusting means 35 adjusts the parameter for the sharpness processing, which is to be performed on the image signal representing the ordinary image in accordance with the USM sharpness processing technique.

The selection of the technique for the sharpness processing and the adjustment of the parameter for the sharpness processing are performed in the manner described above. Thereafter, in a step S180, the processing executing means 40 performs the sharpness processing on the image signal by use of the sharpness processing technique, which has been selected by the sharpness processing technique selecting means 30, and the parameter, which has been adjusted by the parameter adjusting means 35.

As described above, with this embodiment of the image processing apparatus in accordance with the present invention, the kind of the image recording scene, which is represented by the image signal, i.e. the kind of the image signal, is discriminated in accordance with the results of the analysis having been made on the tag information, which acts as the subsidiary information of the image signal, and the results of the analysis having been made on the image signal itself. Also, the technique for the sharpness processing, which is to be performed on the image signal, is selected in accordance with the thus discriminated kind of the image signal. Specifically, in the cases of the image signal, for which it is necessary to suppress the graininess strongly, the sharpness processing technique having the characteristics, such that the processing speed is comparatively low, but the effects of the graininess suppression are large, is selected. Also, in the cases of the image signal, for which it is not necessary to perform strong graininess suppression, the sharpness processing technique having the characteristics, such that the effects of graininess suppression are comparatively small, but the processing speed is high, is selected. Therefore, the efficiency of the sharpness processing is capable of being enhanced. Further, the parameter for the sharpness processing, which is to be performed on the image signal, is not set uniquely and is adjusted in accordance with the kind of the image signal. Accordingly, the quality of the sharpness processing is capable of being enhanced.

The image processing apparatus in accordance with the present invention is not limited to the aforesaid embodiment and may be modified in various other ways.

For example, in the embodiment of FIG. 1, such that the accuracy with which the image signal is discriminated may be enhanced, the kind of the image signal is discriminated in accordance with both the results of the analysis having been made on the subsidiary information of the image signal and the results of the analysis having been made on the image signal itself. Alternatively, the kind of the image signal may be discriminated in accordance with only either one of the results of the analysis having been made on the subsidiary information of the image signal and the results of the analysis having been made on the image signal itself.

Also, the kind of the image signal is not limited to one of the kinds of the image signals described above.

Further, in the aforesaid embodiment of the image processing apparatus in accordance with the present invention, both the sharpness processing technique and the value of the parameter are altered in accordance with the kind of the image signal. Alternatively, only the sharpness processing technique may be altered in accordance with the kind of the image signal, and the value of the parameter for the sharpness processing may be set uniquely. As another alternative, the sharpness processing technique may not be altered, and only the value of the parameter for the sharpness processing may be altered in accordance with the kind of the image signal. With the modifications described above, the sharpness processing of quality better than the quality of the sharpness processing performed by the conventional image processing apparatuses is capable of being performed.

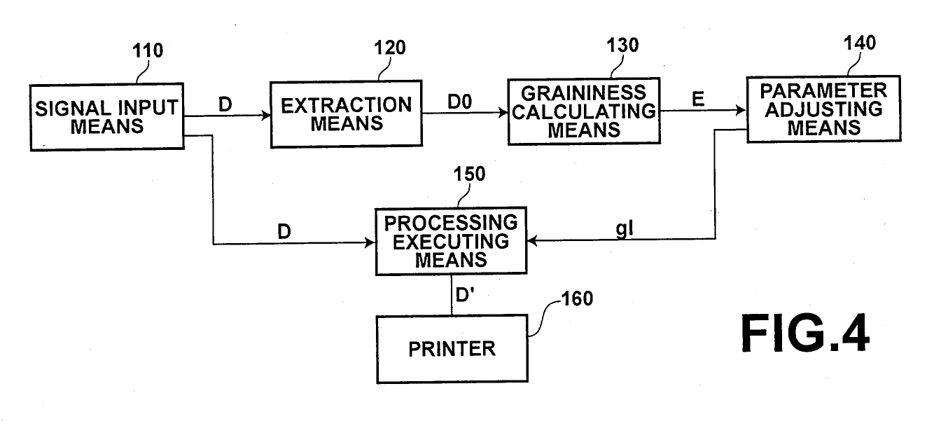

FIG. 4 is a block diagram showing a second embodiment of the image processing apparatus in accordance with the present invention, which is constituted as a printing system.

As illustrated in FIG. 4, the printing system of FIG. 4 comprises signal input means 110 for reading out an image signal D from a recording medium, on which a photographic image signal (hereinbelow referred to simply as the image signal) having been obtained from an image recording operation performed with a digital camera, or for acquiring the image signal D by scanning negative film with a scanner (not shown). The printing system also comprises extraction means 120 for extracting a face region image signal components D0, which represent a face image region embedded in the image represented by the image signal D, from the image signal D. The printing system further comprises graininess calculating means 130 for calculating a graininess E of the face image region by use of the face region image signal components D0. The printing system still further comprises parameter adjusting means 140, which is provided with storage means (not shown) for storing information representing a predetermined appropriate graininess, i.e. a reference graininess E0. The parameter adjusting means 140 adjusts a parameter gₗ for graininess transform processing, which is contained in image structure transform processing to be performed on the image signal D, such that the graininess E calculated by the graininess calculating means 130 becomes close to the reference graininess E0. The printing system also comprises processing executing means 150 for performing the graininess transform processing on the image signal D by use of the contrast-dependent USM technique described above and the parameter gₗ for the graininess transform processing. The processing executing means 150 also performs the sharpness enhancement processing. The printing system further comprises a printer 160 having a 300 dpi resolution. The printer 160 forms a print from a processed image signal D′, which has been obtained from the image structure transform processing performed by the processing executing means 150.

Various techniques have heretofore been proposed for the process for extracting the image signal components, which represent the image region of the face of a person, from the image signal representing the photographic image. In the second embodiment of the image processing apparatus in accordance with the present invention, the image signal components, which represent the face image region, are extracted by use of the technique described in Japanese Unexamined Patent Publication No. 2000-48184. Specifically, firstly, pre-processes, such as a process for reducing the number of pixels in the image and a process for luminance adjustment for the extraction of the face image region, are performed on the image signal, and flesh-color pixels are detected from the pre-processed image signal. Thereafter, a distribution of projection of the flesh-color pixels is obtained from the results of the detection of the flesh-color pixels. Also, a flesh-color mass region, which is characteristic of the face image region, is retrieved in accordance with the pattern of the distribution of projection of the flesh-color pixels, and a candidate for the face image region is found. Finally, a judgment as to whether the candidate for the face image region is or is not the face image region is made with a neural network, or the like, in accordance with a predetermined technique, and the face image region is thus extracted. The image signal components representing the pixels in the thus extracted face image region are taken as the face region image signal components D0.

The graininess calculating means 130 calculates the graininess E of the face image region by use of the face region image signal components D0, which have been extracted by the extraction means 120. How the graininess calculating means 130 operates will hereinbelow be described in detail.

As the graininess E, any of values, which quantitatively represent the grainy feeling of the image represented by the image signal, may be calculated. Also, the graininess E maybe alculated in one of various manners. In this embodiment, the graininess calculating means 130 defines the graininess E and calculates the graininess E in the manner described below.

1. The flattest area, i.e. the area in which little edge component arises, is extracted from the face region image signal components D0. For such purposes, for example, the face region image signal components D0 are divided into blocks, each of which is composed of 256×256 pixels. Also, the R, G, and B signal values of each of the pixels falling within each block are transformed into a luminance signal value Y. Further, a variance value v of the block is calculated with Formula (1) and Formula (2) shown below. A block, which is associated with the variance value v taking the smallest value, is taken as the flattest area.

$$V = \frac{{Σ ( Y ( i , j ) - \overline{Y} )}^{2}}{256 \times 256} \qquad ( 1 )$$

wherein Y represents the luminance value, \overline{Y} represents the mean luminance value of the block, and (i, j) represents the coordinate values of the pixel falling within the block.

$$\overline{Y} = \frac{ΣY ( i , j )}{W} \qquad ( 2 )$$

wherein Y represents the luminance value, W represents the total number of the pixels falling within the block, and (i, j) represents the coordinate values of the pixel falling within the block.

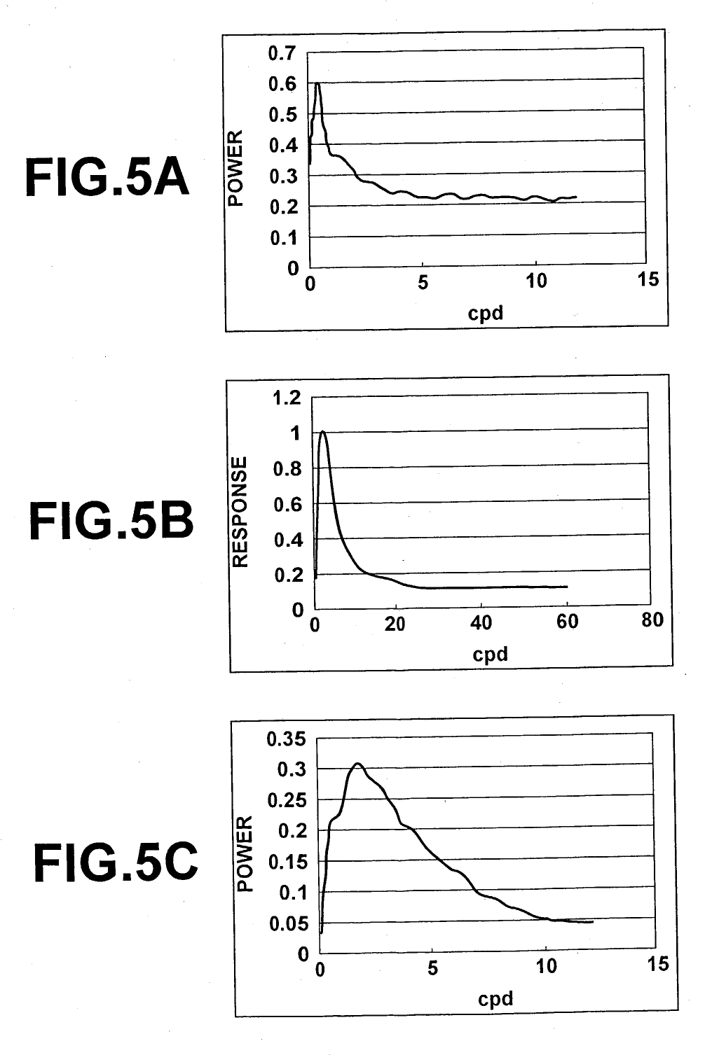

2. FFT transform is performed on the extracted flattest area, and the luminance signals are transformed into frequency signals. The frequency signals are then subjected to a process, in which the unit of the frequency is transformed from a pixel number T per sine wave into cpd (cycle/degree) in accordance with Formula (3) shown below and by use of a resolution DPI of the output device, which is utilized for the outputting of the image signal D (in this case, the output device is the printer 160, and its resolution is 300 dpi), and a specified seeing distance DIST (in this case, 300 mm). In this manner, the frequency characteristics illustrated in FIG. 5A are obtained. The frequency characteristics illustrated in FIG. 5A are then corrected in accordance with the frequency response characteristics of the human's visual system illustrated in FIG. 5B. In this manner, the frequency characteristics illustrated in FIG. 5C are obtained.

$$Frequency ( cpd ) = \frac{DPI}{25.4} \times \frac{π}{180} \times DIST \times \frac{1}{T} \qquad ( 3 )$$

wherein DPI represents the resolution (in units of dpi) of the output device, DIST represents the specified seeing distance (in units of mm), and T represents the pixel number per sine wave.

3. Ordinarily, the grainy components have a size corresponding to a frequency band of 6 cpd to 8 cpd. Therefore, in accordance with FIG. 5C, the mean value of the power of the frequency of the frequency band described above is calculated and taken as the graininess E of the face image region.

In the manner described above, the graininess calculating means 130 calculates the graininess E of the face image region.

In this embodiment, the graininess E is defined and calculated in the frequency domain. Alternatively, the graininess E may be defined and calculated in the spatial domain. For example, firstly, as in the calculation of the graininess E described above, the flattest area, i.e. the area composed of 256×256 pixels, in which little edge component arises, may be extracted from the face region image signal components D0. Also, the RMS value of the luminance signals in the thus extracted area may be calculated with Formula (4) shown below. The calculated RMS value may then be taken as the graininess E of the face region image signal components D0.

$$R MS = \sqrt{\frac{{Σ ( Y ( i , j ) - \overline{Y} )}^{2}}{W}} \qquad ( 4 )$$

wherein Y represents the luminance value, \overline{Y} represents the mean luminance value of the block, W represents the total number of the pixels falling within the block, and (i, j) represents the coordinate values of the pixel falling within the block.

In accordance with the graininess E of the face image region having been calculated by the graininess calculating means 130, the parameter adjusting means 140 adjusts the parameter gₗ for the graininess transform processing, such that the graininess E becomes close to the predetermined reference graininess E0 (in this case, 0.105). The adjustment is made in accordance with Formula (5) shown below.

gₗ=4000×(E0-E) (5)

wherein gₗ represents the parameter for the graininess transform processing, E0 represents the reference graininess, and E represents the graininess of the face image region.

The parameter gₗ for the graininess transform processing takes a positive value or a negative value in accordance with the difference between the reference graininess E0 and the graininess E of the face image region embedded in the image represented by the image signal D. In the image structure transform processing performed with the contrast-dependent USM technique, in cases where the parameter gₗ for the graininess transform processing takes a positive value, and the absolute value of the positive value is large, the grainy components are enhanced to a high extent. In cases where the parameter gₗ for the graininess transform processing takes a negative value, and the absolute value of the negative value is large, the grainy components are suppressed strongly.

The information, which represents the parameter gₗ for the graininess transform processing having been adjusted by the parameter adjusting means 140, is fed into the processing executing means 150 and utilized in the image structure transform processing performed by the processing executing means 150.

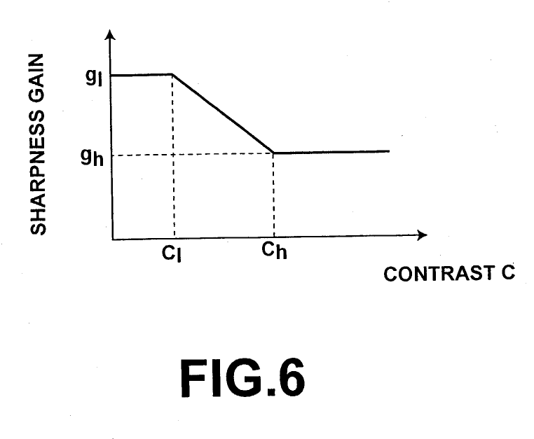

As illustrated in FIG. 6, the processing executing means 150 performs the image structure transform processing on the image signal D by using different degrees of enhancement, i.e. different sharpness gains, for the high frequency components in accordance with the contrast C. Specifically, with respect to the pixels of low contrast C (C≦Cₗ, where Cₗ represents the threshold value for discrimination of the low contrast), a sharpness gain gₗ for the low contrast region is utilized. With respect to the pixels of high contrast C (C≧Cₕ, where Cₕ represents the threshold value for discrimination of the high contrast), a sharpness gain gₕ for the high contrast region is utilized. Also, with respect to the pixels of intermediate contrast C (Cₗ<C<Cₕ), a sharpness gain g, which takes a value between gₕ and gₗ and linearly depends upon the contrast C in accordance with Formula (6) shown below, is utilized.

$$g ( i , j ) = \frac{{g}_{ι} * {C}_{h} - {g}_{h} * {C}_{ι}}{{C}_{h} - {C}_{ι}} - ( \frac{{g}_{ι} - {g}_{h}}{{C}_{h} - {C}_{ι}} ) * C ( i , j ) \qquad ( 6 )$$

wherein g represents the sharpness gain, gₗ represents the sharpness gain for the low contrast region, gₕ represents the sharpness gain for the high contrast region, Cₗ represents the threshold value for discrimination of the low contrast, Cₕ represents the threshold value for discrimination of the high contrast, C represents the contrast, and (i, j) represents the coordinate values of the pixel.

As the sharpness gain gₕ for the high contrast region, a value determined previously in the system may be utilized. As the sharpness gain gₗ for the low contrast region, the parameter gₗ for the graininess transform processing, which parameter has been adjusted by the parameter adjusting means 140, is utilized.

The image structure transform processing is performed by the processing executing means 150 and in accordance with Formula (7) shown below.

$$\{ \begin{matrix}{R}^{′} ( i , j ) = R ( i , j ) + g ( i , j ) & ( Y ( i , j ) - {Y}_{us} ( i , j ) ) \\ {G}^{′} ( i , j ) = G ( i , j ) + g ( i , j ) & ( Y ( i , j ) - {Y}_{us} ( i , j ) ) \\ {B}^{′} ( i , j ) = B ( i , j ) + g ( i , j ) & ( Y ( i , j ) - {Y}_{us} ( i , j ) )\end{matrix} \qquad ( 7 )$$

wherein Y represents the luminance signal value, Yᵤₛ represents the unsharp masking luminance signal value, R, G, and B represent the signal values before being processed, R′, G′, and B′ represent the signal values after being processed, g represents the sharpness gain, and (i, j) represents the coordinate values of the pixel.

The processing executing means 150 feeds out the processed image signal D′, which has been obtained from the image structure transform processing performed on the image signal D, to the printer 160. The printer 160 forms the print from the processed image signal D′.

The aforesaid second embodiment of the image processing apparatus in accordance with the present invention, which is constituted as the printing system, is based upon the findings in that, as for reproduced images (in the cases of the printing system, the prints), there are strict requirements for the graininess characteristics of face image regions in images of persons. Specifically, with the second embodiment of the image processing apparatus in accordance with the present invention, the parameter for the graininess transform processing, which is to be performed on the image signal, is adjusted such that the graininess of the face image region embedded in the image represented by the image signal becomes close to the reference graininess of the face image region. The graininess transform processing is then performed by use of the thus adjusted parameter for the graininess transform processing. Therefore, the image structure transform processing is capable of being performed reliably with respect to the image signals, which have been acquired from different kinds of sources, and reproduced images having desirable image quality are capable of being obtained from the image signals, which have been acquired from different kinds of sources.

The aforesaid second embodiment of the image processing apparatus in accordance with the present invention, which is constituted as the printing system, may be modified in various other ways with respect to the definition of the graininess, the calculation of the graininess, the kind of the output device, the kind of the image signal, and the like.

For example, in the second embodiment described above, the parameter gₗ for the graininess transform processing is adjusted in accordance with Formula (5) shown above. Specifically, the difference between the reference graininess E0 and the graininess E of the face image region embedded in the image represented by the image signal D is multiplied by a value of 4,000, and the thus obtained value is taken as the parameter gₗ for the graininess transform processing. However, the value, by which the difference described above is multiplied, is not limited to 4,000 and may be set at 2,000, 3,000, or the like. In such cases, the parameter gₗ for the graininess transform processing is capable of being adjusted such that the graininess of the face image region becomes close to the reference graininess E0.

Also, the processing executing means 150 performs the image structure transform processing by utilizing the contrast-dependent USM technique. Alternatively, the image structure transform processing, wherein the graininess transform processing is performed, may be performed in various other ways.

Further, in the second embodiment described above, as an aid in facilitating the explanation, when the image signal D is to be fed out into the printer 160, only the image structure transform processing is performed. However, in such cases, other processes, such as a gradation correcting process and a color correcting process, may also be performed.

Furthermore, the output device is not limited to the printer and may be a monitor, or the like.

What is claimed is:

1. An image processing method, in which sharpness processing is performed on an image signal having been acquired with a digital camera, the method comprising the steps of:
i) discriminating a kind of the image signal and/or image recording conditions associated with the image signal,
ii) adjusting a parameter for the sharpness processing, which is to be performed on the image signal, in accordance with the kind of the image signal and/or the image recording conditions associated with the image signal, which have thus been discriminated, and
iii) performing the sharpness processing on the image signal by use of the thus adjusted parameter for the sharpness processing.

2. A method as defined in claim 1 wherein the discrimination of the kind of the image signal and/or the image recording conditions associated with the image signal is performed by making an analysis of subsidiary information of the image signal and/or an analysis of the image signal.

3. An image processing method, in which sharpness processing is performed on an image signal having been acquired with a digital camera, the method comprising the steps of:
i) discriminating a kind of the image signal and/or image recording conditions associated with the image signal,
ii) selecting a technique for the sharpness processing, which is to be performed on the image signal, in accordance with the kind of the image signal and/or the image recording conditions associated with the image signal, which have thus been discriminated, and
iii) performing the sharpness processing on the image signal by use of the thus selected technique for the sharpness processing.

4. A method as defined in claim 3 wherein the discrimination of the kind of the image signal and/or the image recording conditions associated with the image signal is performed by making an analysis of subsidiary information of the image signal and/or an analysis of the image signal.

5. An image processing apparatus, in which sharpness processing is performed on an image signal having been acquired with a digital camera, the apparatus comprising:
i) discrimination means for discriminating a kind of the image signal and/or image recording conditions associated with the image signal, and
ii) processing means for adjusting a parameter for the sharpness processing, which is to be performed on the image signal, in accordance with the kind of the image signal and/or the image recording conditions associated with the image signal, which have been discriminated by the discrimination means, and performing the sharpness processing on the image signal by use of the thus adjusted parameter for the sharpness processing.

6. An apparatus as defined in claim 5 wherein the discrimination means performs the discrimination of the kind of the image signal and/or the image recording conditions associated with the image signal by making an analysis of subsidiary information of the image signal and/or an analysis of the image signal.

7. An image processing apparatus, in which sharpness processing is performed on an image signal having been acquired with a digital camera, the apparatus comprising:
i) discrimination means for discriminating a kind of the image signal and/or image recording conditions associated with the image signal, and
ii) processing means for selecting a technique for the sharpness processing, which is to be performed on the image signal, in accordance with the kind of the image signal and/or the image recording conditions associated with the image signal, which have been discriminated by the discrimination means, and performing the sharpness processing on the image signal by use of the thus selected technique for the sharpness processing.

8. An apparatus as defined in claim 7 wherein the discrimination means performs the discrimination of the kind of the image signal and/or the image recording conditions associated with the image signal by making an analysis of subsidiary information of the image signal and/or an analysis of the image signal.

9. A computer program for causing a computer to execute processing, in which sharpness processing is performed on an image signal having been acquired with a digital camera, the computer program comprising the procedures for:
i) a discrimination process for discriminating a kind of the image signal and/or image recording conditions associated with the image signal,
ii) a parameter adjusting process for adjusting a parameter for the sharpness processing, which is to be performed on the image signal, in accordance with the kind of the image signal and/or the image recording conditions associated with the image signal, and
iii) an execution process for performing the sharpness processing on the image signal by use of the adjusted parameter for the sharpness processing.

10. A computer program for causing a computer to execute processing, in which sharpness processing is performed on an image signal having been acquired with a digital camera, the computer program comprising the procedures for:
i) a discrimination process for discriminating a kind of the image signal and/or image recording conditions associated with the image signal,
ii) a technique selecting process for selecting a technique for the sharpness processing, which is to be performed on the image signal, in accordance with the kind of the image signal and/or the image recording conditions associated with the image signal, and
iii) an execution process for performing the sharpness processing on the image signal by use of the selected technique for the sharpness processing.

11. An image processing method, comprising the steps of:
i) storing information, which represents a reference graininess of a face image region embedded in a photographic image,
ii) extracting image signal components, which represent the face image region, from an image signal representing the photographic image,
iii) calculating graininess of the face image region from the thus extracted image signal components, which represent the face image region,
iv) adjusting a parameter for graininess transform processing, which is to be performed on the image signal, such that the graininess of the face image region becomes close to the reference graininess of the face image region, and
v) performing the graininess transform processing by use of the thus adjusted parameter for the graininess transform processing.

12. An image processing apparatus, comprising:
i) storage means for storing information, which represents a reference graininess of a face image region embedded in a photographic image,
ii) extraction means for extracting image signal components, which represent the face image region, from an image signal representing the photographic image,
iii) graininess calculating means for calculating graininess of the face image region from the extracted image signal components, which represent the face image region,
iv) parameter adjusting means for adjusting a parameter for graininess transform processing, which is to be performed on the image signal, such that the graininess of the face image region becomes close to the reference graininess of the face image region, and
v) transform means for performing the graininess transform processing by use of the parameter for the graininess transform processing, which parameter has been adjusted by the parameter adjusting means.

13. A computer program for causing a computer to execute processing, in which graininess transform processing is performed on an image signal representing a photographic image, the computer program comprising the procedures for:
i) an extraction process for extracting image signal components, which represent a face image region, from the image signal representing the photographic image,
ii) a graininess calculating process for calculating graininess of the face image region from the extracted image signal components, which represent the face image region,
iii) a parameter adjusting process for adjusting a parameter for graininess transform processing, which is to be performed on the image signal, such that the graininess of the face image region becomes close to the reference graininess of the face image region, and
iv) a transform process for performing the graininess transform processing on the image signal by use of the adjusted parameter for the graininess transform processing.

14. A computer readable recording medium, on which a computer program for causing a computer to execute processing has been recorded and from which the computer is capable of reading the computer program, the processing comprising performing sharpness processing on an image signal having been acquired with a digital camera,
wherein the computer program comprises the procedures for:
i) a discrimination process for discriminating a kind of the image signal and/or image recording conditions associated with the image signal,
ii) a parameter adjusting process for adjusting a parameter for the sharpness processing, which is to be performed on the image signal, in accordance with the kind of the image signal and/or the image recording conditions associated with the image signal, and
iii) an execution process for performing the sharpness processing on the image signal by use of the adjusted parameter for the sharpness processing.

15. A computer readable recording medium, on which a computer program for causing a computer to execute processing has been recorded and from which the computer is capable of reading the computer program, the processing comprising performing sharpness processing on an image signal having been acquired with a digital camera,
wherein the computer program comprises the procedures for:
i) a discrimination process for discriminating a kind of the image signal and/or image recording conditions associated with the image signal,
ii) a technique selecting process for selecting a technique for the sharpness processing, which is to be performed on the image signal, in accordance with the kind of the image signal and/or the image recording conditions associated with the image signal, and
iii) an execution process for performing the sharpness processing on the image signal by use of the selected technique for the sharpness processing.

16. A computer readable recording medium, on which a computer program for causing a computer to execute processing has been recorded and from which the computer is capable of reading the computer program, the processing comprising performing graininess transform processing on an image signal representing a photographic image,
wherein the computer program comprises the procedures for:
i) an extraction process for extracting image signal components, which represent a face image region, from the image signal representing the photographic image,
ii) a graininess calculating process for calculating graininess of the face image region from the extracted image signal components, which represent the face image region,
iii) a parameter adjusting process for adjusting a parameter for graininess transform processing, which is to be performed on the image signal, such that the graininess of the face image region becomes close to the reference graininess of the face image region, and
iv) a transform process for performing the graininess transform processing on the image signal by use of the adjusted parameter for the graininess transform processing.
